(19) United States
(12) Patent Application Publication
(10) Pub. No.: US 2026/0202561 A1
(43) Pub. Date: Jul. 16, 2026

(54) IMAGE PROCESSING APPARATUS, RADIOGRAPHIC IMAGING SYSTEM, IMAGE PROCESSING METHOD OF IMAGE PROCESSING APPARATUS, AND STORAGE MEDIUM

(71) Applicant: CANON KABUSHIKI KAISHA, Tokyo (JP)

(72) Inventor: TSUYOSHI KOBAYASHI, Kanagawa (JP)

(21) Appl. No.: 19/438,220

(22) Filed: Dec. 31, 2025

(30) Foreign Application Priority Data
Jan. 15, 2025 (JP) 2025-005362

(51) Int. Cl. G01T 1/29; G06T 7/246

(52) U.S. Cl. CPC G01T 1/2992; G06T 7/251; G06T 2207/10116; G06T 2207/20182

(57) ABSTRACT

Some embodiments of an image processing apparatus comprise at least one processor and at least one memory that is in communication with the at least one processor. The at least one memory stores instructions for causing the at least one processor and the at least one memory to acquire a frame image including noise less than noise of a plurality of second frame images using the plurality of second frame images and using at least one of a first frame image and a third frame image. A moving image includes the first frame image, the plurality of second frame images, and the third frame image. The plurality of second frame images was captured before the first frame image was captured. The third frame image was captured before the plurality of second frame images was captured.

### BACKGROUND

### Field of the Technology

The present disclosure relates to an image processing apparatus, a radiographic imaging system, an image processing method of the image processing apparatus, and a storage medium.

### Description of the Related Art

In recent years, there has been a widely used radiographic imaging system including a detection unit for detecting radiation, such as X-rays, in the industrial field, the medical field, and other fields. Especially, in the X-ray moving image capturing field, there has been a widely used digital radiographic imaging system that converts incident X rays into visible light using a scintillator to acquire a moving image using a semiconductor sensor. The moving image described above refers to a set of a plurality of continuously captured still images, and hereinafter, each of the individual still images in the moving image is referred to as a frame.

In such a radiographic imaging system, various types of image processing are applied to images acquired by the semiconductor sensor to increase diagnostic performance (an index representing a diagnostic imaging value). Example of the image processing includes noise reduction processing. There is a known phenomenon in which various types of noise are generated, such as quantum noise due to fluctuations in X-ray quanta and system noise generated from a detector and a circuit, and the generated noise is superimposed on the images during a series of image capturing processing. This phenomenon may deteriorate the granularity of the acquired moving image, decreasing the diagnostic performance.

Especially, to perform medical X-ray moving image capturing, image capturing with a low X-ray dose is recommended from the viewpoint of radiation exposure to a subject being examined. In order to increase the diagnostic performance, it thus is important to apply image processing for suitably reducing noise to the captured image to enhance the image quality.

Since the same object is continuously captured in moving image capturing, it is important that the moving image capturing produce little flicker (a phenomenon in which the brightness of the moving image fluctuates slightly) in signals from the object between frames.

Further, in the moving image capturing, it is necessary to acquire a moving image in which a moving object can be clearly viewed. Thus, it is important that image persistence be minimized.

Japanese Patent Laid-open No. 2013-48782 describes a rule-based technique for suitably reducing noise. Specifically, the technique includes generating a rule that accurately determines the motion of an object from a moving image with the impact of noise taken into consideration, and performing weighted addition to a plurality of frames of the moving image in chronological order based on the determination result. Further, in recent years, noise reduction processing with higher performance to which a machine learning-based technique, such as deep learning, is applied has been put into practical use. "FastDVDnet: Towards Real-Time Deep Video Denoising Without Flow Estimation", M Tassano, et.al, IEEE/CVF Conference on Computer Vision and Pattern Recognition (CVPR), 2020, pp. 1354 to 1363, describes a technique of inputting the frames preceding and following a frame subject to noise reduction to acquire a noise-reduced image using a trained neural network.

According to Japanese Patent Laid-open No. 2013-48782, the weighted addition of a combination of temporal information and spatial information about a signal can be performed using the image of the frame before a current frame (hereinafter, referred to as a previous frame) by combining a rule-based motion detection and a recursive filter. Further, according to Japanese Patent Laid-open No. 2013-48782, the weight of the temporal information and the weight of the spatial information can be arbitrarily changed. Consequently, the effects of noise reduction and image persistence reduction can be changed. On the other hand, by the rule-based motion detection processing, it is difficult to generate an appropriate rule for each of the various types of motion of the object. Thus, image persistence may occur along with noise reduction for a frequently moving object.

Further, the technique described in "FastDVDnet:Towards Real-Time Deep Video Denoising Without Flow Estimation", M Tassano, et.al, IEEE/CVF Conference on Computer Vision and Pattern Recognition (CVPR), 2020, pp. 1354 to 1363, provides excellent effect of noise reduction of noise and image persistence compared with the rule-based processing, by the processing to which the machine learning-based technique is applied. However, the internal processing performed by a neural network is a black box. It thus is difficult to change the amount of image persistence reduced by, for example, changing parameters for a trained neural network (a trained model). For this reason, image persistence may become large for a fast-moving object.

### SUMMARY

Embodiments of the present disclosure are directed to providing an image processing apparatus capable of performing noise reduction processing using a trained model, and changing the amount of image persistence reduced.

According to an aspect of the present disclosure, an image processing apparatus comprises at least one processor and at least one memory that is in communication with the at least one processor. The at least one memory stores instructions for causing the at least one processor and the at least one memory to acquire a frame image including noise less than noise of a plurality of second frame images using the plurality of second frame images and using at least one of a first frame image and a third frame image. A moving image includes the first frame image, the plurality of second frame images, and the third frame image. The plurality of second frame images was captured before the first frame image was captured. The third frame image was captured before the plurality of second frame images was captured.

Features of various embodiments of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic diagrams illustrating a configuration example of a radiographic imaging system and a radiation detector according to a first embodiment.

FIGS. 2A and 2B illustrate a schematic configuration example of a control unit according to the first embodiment.

FIGS. 3A to 3C are diagrams illustrating general configuration examples of a trained model, and operation examples thereof according to the first embodiment.

FIGS. 4A, 4B, 4C, and 4D are diagrams each illustrating a schematic configuration example of a convolutional neural network (CNN) according to the first embodiment.

FIG. 5 is a diagram illustrating an operation example of a noise reduction processing unit according to the first embodiment.

FIG. 6 is a flowchart illustrating an operation of the radiographic imaging system according to the first embodiment.

FIG. 7 is a flowchart illustrating an operation of the radiographic imaging system according to the first embodiment.

### DESCRIPTION OF THE EMBODIMENTS

An example embodiment will now be described with reference to the attached drawings.

However, dimensions, materials, and shapes of, and relative positions between components described in the following embodiment can be desirably determined and changed depending on various conditions or the configuration of an apparatus to which the present disclosure is applied. Further, like reference numerals refer to the same components or components having similar features across the drawings.

A radiographic imaging system that uses X-rays as an example of radiation will be described. However, the radiation may be X-rays, or other types of radiation. In the following embodiment, the term “radiation” can include electromagnetic radiation, such as X rays and γ rays, and particle radiation, such as α rays, β rays, particle beams, proton rays, heavy-ion rays, and meson rays.

Further, in the following, a machine learning model refers to a model trained by a machine learning algorithm. Examples of specific machine learning algorithms include a nearest neighbor method, a Naive Bayes method, a decision tree method, and a support vector machine method. Further, neural networks or deep learning may be used. Any usable method from the above-described algorithms can be applied to the following embodiment and modification examples. Further, the training data is a data set used for training a machine learning model, and includes a pair of input data input to the machine learning model and ground truth data (teacher data), which serves as the correct answers for output results of the machine learning model.

In addition, a trained model is a model trained using appropriate training data in advance for a machine learning model in accordance with an arbitrary machine learning algorithm, such as deep learning. However, the trained model is achieved by training using appropriate training data in advance, but it does not mean that the training more than that is not performed, and additional training can be performed. The additional training can also be performed after the apparatus is installed at an intended location.

### First Embodiment

### Configuration of Radiographic Imaging System

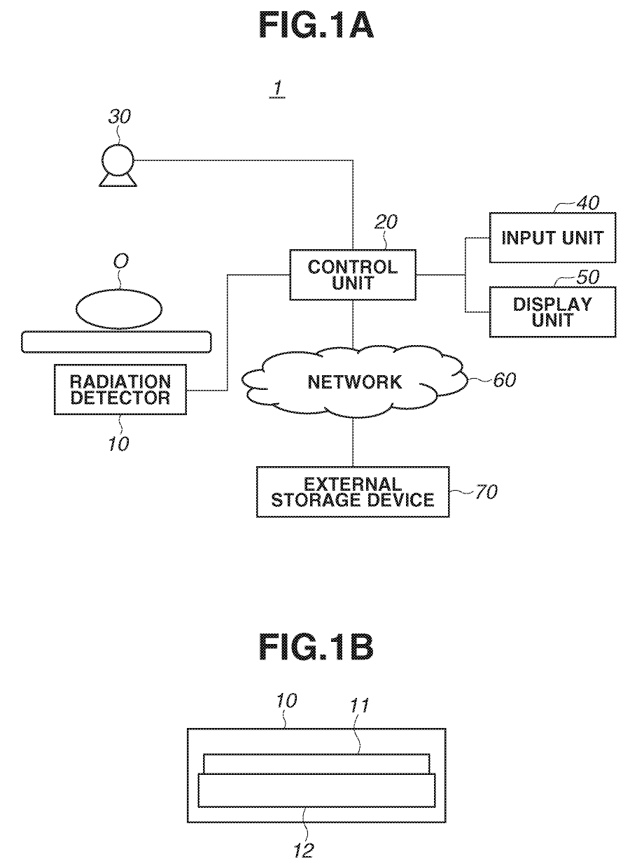

A radiographic imaging system, an image processing apparatus, and an operation method of the image processing apparatus according to a first embodiment will now be described with reference to FIGS. 1A and 1B.

FIG. 1A is a schematic diagram illustrating a configuration example of a radiographic imaging system 1 according to the present embodiment.

Further, in the following description, a case will be described where an object O to be examined is a human body, but the object O captured by the radiographic imaging system according to the present disclosure is not limited to a human body, and may be an animal, a plant, or an object subject to a non-destructive inspection, other than a human body.

The radiographic imaging system 1 according to the present embodiment includes a radiation detector 10, a control unit 20, a radiation generator 30, an input unit 40, and a display unit 50. Further, the radiographic imaging system 1 may include an external storage device 70, such as a server connected to the control unit 20 via a network 60, such as the Internet or an intranet.

The radiation generator 30 includes a radiation source, such as an X-ray tube, which can emit radiation. The radiation detector 10 can detect radiation emitted from the radiation generator 30 to generate a radiation image corresponding to the detected radiation. Thus, the radiation detector 10 can generate a radiation image of the object O by detecting the radiation, which is emitted from the radiation generator 30, having passed through the object O.

FIG. 1B is a schematic diagram illustrating a configuration example of the radiation detector 10 according to the present embodiment. The radiation detector 10 includes a scintillator 11 and an image sensor 12. The scintillator 11 converts the radiation incident on the radiation detector 10 into light having a wavelength detectable by the image sensor 12. The scintillator 11 may include, for example, cesium iodide (CsI) or gadolinium oxysulfide (Gd₂O₂S (GOS)).

The image sensor 12 includes a photoelectric conversion device made of, for example, amorphous silicon or crystalline silicon, which can detect light corresponding to the radiation converted by the scintillator 11, and then output a signal corresponding to the detected light. The radiation detector 10 can generate a radiation image by performing analog-to-digital (A/D) conversion and the like on the signal output by the image sensor 12.

Further, while not illustrated in FIG. 1B, the radiation detector 10 may include a calculation unit or an A/D conversion unit. Further, a grid may be arranged between the radiation detector 10 and the object O so as to reduce scattered radiation that is generated when the radiation passes through the object O and that reaches the radiation detector 10.

The control unit 20 is connected to the radiation detector 10, the radiation generator 30, the input unit 40, and the display unit 50. The control unit 20 can acquire a radiation image output from the radiation detector 10 to perform image processing on the acquired radiation image, and can control the driving of the radiation detector 10 and the radiation generator 30. With this configuration, the control unit 20 can generate radiation for a predetermined imaging condition at appropriate timing by controlling the radiation generator 30, allowing a moving image to be captured at a desired frame rate. Further, the control unit 20 can function as an example of the image processing apparatus.

In addition, the control unit 20 may be connected to the external storage device 70 via the network 60, such as the Internet or an intranet, to acquire a radiation image or the like from the external storage device 70. Further, the control unit 20 can be connected to another radiation detector, another radiation generator, or the like via the network 60. In addition, the control unit 20 can be connected by wire or wirelessly to the external storage device 70 and the like.

The input unit 40 includes an input device, such as a mouse, a keyboard, a trackball, and a touch panel, and instructions can be input to the control unit 20 by an operator operating the input unit 40. The display unit 50 includes, for example, any type of monitor, which displays information and images output from the control unit 20, information input from the input unit 40, and the like.

In addition, in the present embodiment, the control unit 20, the input unit 40, the display unit 50, and the like are configured as separate devices, but those devices may be integrally configured. For example, the input unit 40 and the display unit 50 may be integrally configured using a touch panel display. Further, in the present embodiment, the image processing apparatus includes the control unit 20, but it is sufficient for the image processing apparatus to be able to acquire a radiation image to perform image processing on the radiation image, and the image processing apparatus may not control the driving of the radiation detector 10 or the radiation generator 30.

Further, the control unit 20, the radiation detector 10, the radiation generator 30, and the like can be connected by wire or wirelessly. In addition, the external storage device 70 may be included in an image system, such as a picture archiving communication system (PACS) in a hospital, or may be a server or the like installed outside the hospital.

### Configuration of Control Unit

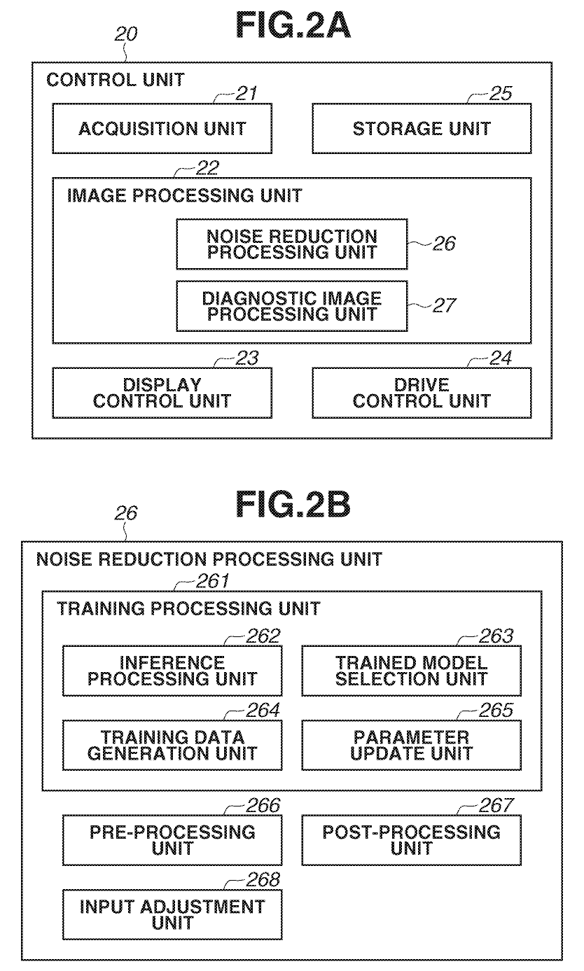

A specific configuration of the control unit 20 will now be described with reference to FIGS. 2A and 2B.

FIG. 2A illustrates a configuration example of the control unit 20 according to the present embodiment, and FIG. 2B illustrates a configuration example of a noise reduction processing unit 26 according to the present embodiment. The control unit 20 includes an acquisition unit 21, an image processing unit 22, a display control unit 23, a drive control unit 24, and a storage unit 25.

The acquisition unit 21 can acquire a radiation image output from the radiation detector 10, various types of information input using the input unit 40, and the like. Further, the acquisition unit 21 can acquire radiation images and patient information from the external storage device 70 or the like.

The image processing unit 22, including the noise reduction processing unit 26 and a diagnostic image processing unit 27, can perform image processing according to the present embodiment on radiation images acquired by the acquisition unit 21. In the present embodiment, noise reduction processing will be described as an example of image processing performed by the image processing unit 22.

As illustrated in FIG. 2B, the noise reduction processing unit 26 includes a training processing unit 261. The training processing unit 261 includes an inference processing unit 262, a trained model selection unit 263, a training data generation unit 264, and a parameter update unit 265. Further, the noise reduction processing unit 26 includes a pre-processing unit 266 that converts an image input to the noise reduction processing unit 26 into a form suitable for processing by the training processing unit 261, and a post-processing unit 267 that applies appropriate processing to an output result of the training processing unit 261. Further, the noise reduction processing unit 26 includes an input adjustment unit 268 configured to select images input to the noise reduction processing unit 26 and arrange the selected images in an appropriate form. This configuration allows the noise reduction processing unit 26 to train a machine learning model used to perform noise reduction processing. Further, the noise reduction processing unit 26 can apply noise reduction processing suitable for radiation images by using a trained machine learning model. In addition, the noise reduction processing unit 26 may perform noise reduction processing by using parameters learned by another learning device. In other words, the noise reduction processing unit 26 may not have a configuration capable of performing both training of a machine learning model and noise reduction processing (inference processing using the learned parameters).

Further, the diagnostic image processing unit 27 can perform diagnostic image processing for converting an image with noise reduced by the noise reduction processing unit 26 into an image suitable for diagnosis. Examples of the diagnostic image processing include gradation processing for adjusting gradation of an image, enhancement processing for emphasizing specific pixels in an image, and grid artifact reduction processing for reducing grid lines and moiré pattern in an image. In addition, for example, the diagnostic image processing unit 27 may perform the gradation processing, the enhancement processing, the grid artifact reduction processing, and the like based on a region of interest (ROI) set in a radiation image. For example, the gradation processing can be performed so that the gradation becomes a wider ROI, and the enhancement processing can be performed so as to emphasize an ROI. In this case, the ROI can be set based on an instruction from the operator, or can be set based on a portion captured in image capturing, information about a disease name, finding information, or the like.

A configuration of the training processing unit 261 will now be described. The training processing unit 261 performs training processing applied when the machine learning model is trained. The training processing unit 261 includes the inference processing unit 262, the trained model selection unit 263, the training data generation unit 264, and the parameter update unit 265.

When the training processing is performed, first, the input adjustment unit 268 adjusts input data for the training processing unit 261. Then, an image is input on which pre-processing is performed as appropriate by the pre-processing unit 266. Then, the training data generation unit 264 generates training data. In the present embodiment, as a training data set for learning noise reduction processing, a configuration example will be described that uses an image (input data) with artificial noise added thereto, and an image (ground truth data) without the artificial noise. The training data generation unit 264 performs processing of generating the training data set by adding to an input image the artificial noise generated by simulating features of the radiation image. At this time, the noise added by the training data generation unit 264 may reflect an amount of noise calculated by the training data generation unit 264 that can vary due to manufacturing variations of the radiation detector 10. Details of the training processing will be described below.

The parameter update unit 265 performs processing of updating parameters of a machine learning model held by the inference processing unit 262 based on a calculation result for the input data by the inference processing unit 262 and the ground truth data.

The inference processing unit 262 generates an image obtained by applying the image processing on a radiation image by the inference processing when the radiation image is input to a model trained using the above-described training data. Further, the trained model selection unit 263 selects a trained model to be used by the inference processing unit 262. At this time, a plurality of trained models obtained by a series of training processing by the training processing unit 261 may be prepared, for example, for each type of the radiation detector 10. Alternatively, a plurality of trained models may be prepared for each type of the scintillator 11. A plurality of trained models may be prepared for each type of the image sensor 12. A plurality of trained models may be prepared for each of binning, sensitivity, captured image size, frame rate, and imaging procedure for a single model of the radiation detector 10. At least one trained model to be used by the inference processing unit 262 is selected by the trained model selection unit 263 from among the plurality of trained models. Details of the inference processing will be described below.

In the present embodiment, a part of the training processing unit 261 does not need to be included in the control unit 20. For example, the components other than the inference processing unit 262 and the trained model selection unit 263 may be configured in another hardware device (e.g., a server) different from the control unit 20. The hardware device generates a trained model by being trained using appropriate training data in advance. In this case, the control unit 20 may cause the inference processing unit 262 to access the different hardware device to acquire the trained model, and then to perform the processing alone that uses the trained model. Further, with the trained model generated in advance arranged in the noise reduction processing unit 26, the control unit 20 may perform the processing alone that uses the trained model.

Alternatively, the control unit 20 may be configured to perform the additional training using training data acquired after the control unit 20 is installed (sold) in a customer site by including the training processing unit 261 in the control unit 20.

The display control unit 23 can control the display of the display unit 50. For example, the display control unit 23 causes the display unit 50 to display radiation images before and after the image processing performed by the image processing unit 22, patient information, or the like. The drive control unit 24 can control the driving of the radiation detector 10, the radiation generator 30, and the like. Thus, the control unit 20 can control the driving of the radiation detector 10 and the radiation generator 30 to control the capturing of radiation images using the drive control unit 24.

The storage unit 25 can store an operating system (OS), device drivers for peripheral devices, and programs for implementing various types of application software including programs for performing processing described below or the like. Further, the storage unit 25 can store information acquired by the acquisition unit 21, radiation images subjected to image processing using the image processing unit 22, and the like. For example, the storage unit 25 can store radiation images acquired by the acquisition unit 21, and radiation images subjected to noise reduction processing described below.

In addition, the control unit 20 can be configured using a general-purpose computer including a processor and a memory, but may be configured using a computer dedicated to the radiographic imaging system 1. In the present embodiment, the control unit 20 functions as an example of the image processing apparatus according to the present embodiment, but the image processing apparatus according to the present embodiment may be a separate (external) computer communicably connected to the control unit 20. Further, the control unit 20 and the image processing apparatus may be configured using personal computers (PCs), desktop PCs, laptop PCs, or tablet PCs (portable information terminals). In addition, the processor may be a central processing unit (CPU). Further, the processor may be, for example, a micro processing unit (MPU), a graphics processing unit (GPU), or a field-programmable gate array (FPGA).

Each function of the control unit 20 may be implemented by a processor, such as a CPU or an MPU, executing a software module stored in the storage unit 25. In addition, the processor may be, for example, a GPU or an FPGA. Further, each function may be implemented by a circuit, such as an Application Specific Integrated Circuit (ASIC) that performs a specific function. For example, the image processing unit 22 may be implemented as a dedicated hardware component, such as an ASIC, and the display control unit 23 may be implemented using a dedicated processor, such as a GPU different from a CPU. The storage unit 25 can be configured as any storage medium, for example, an optical disk, a hard disk, or a memory.

### Configuration of Machine Learning Model

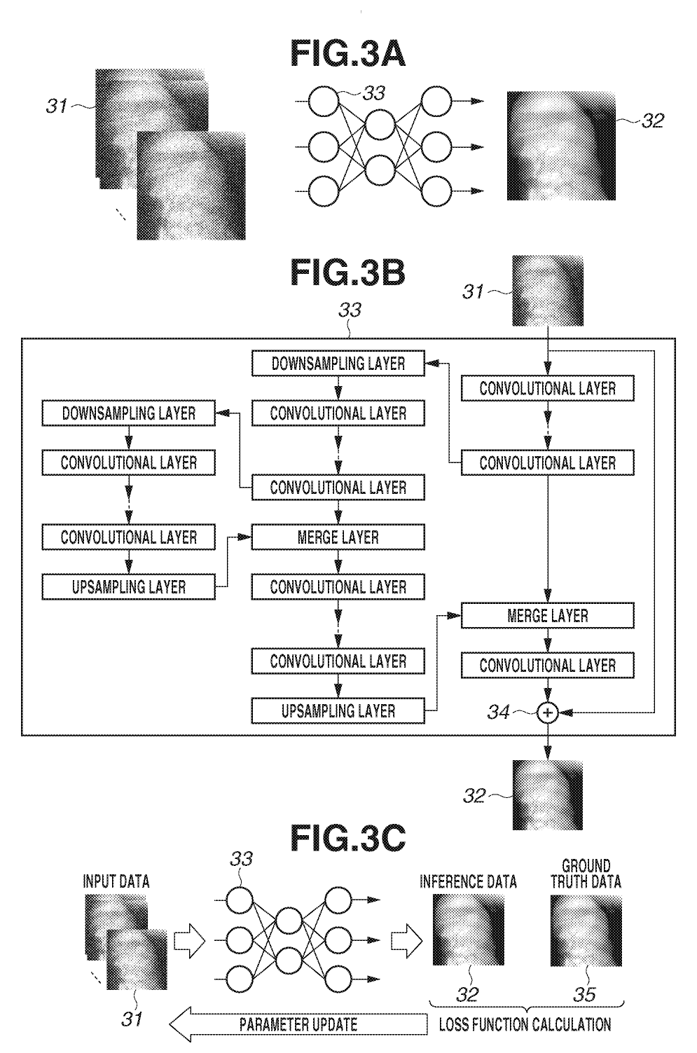

An example will now be described of a machine learning model included in a trained model according to the present embodiment with reference to FIGS. 3A, 3B, and 3C. An example of the machine learning model used by the inference processing unit 262 according to the present embodiment is a multiple-layered neural network.

FIG. 3A is a schematic diagram illustrating a neural network model according to the present embodiment. A configuration 33 of the neural network model illustrated in FIG. 3A is designed to output noise-reduced inference data 32 for input data 31 based on the tendencies learned in advance. The output noise-reduced inference data 32 is based on the learning content in the machine learning process. The neural network according to the present embodiment learns features for distinguishing between the signal and the noise included in an input radiation image. In addition, in the example illustrated in FIG. 3A, the input data 31 includes a current frame and one or more previous frames before the current frame. Alternatively, the input data 31 includes a current frame and one or more future frames after the current frame. Alternatively, the input data 31 includes either a group of a current frame and one or more previous frames before the current frame or a group of the current frame and a future frame. The noise-reduced inference data 32 is a frame with the noise in the current frame reduced. In addition, a trained model with one frame input therein as a current frame (a single frame) that constitutes the input data 31 can be configured.

In addition, for example, a convolutional neural network (CNN) can be used as at least a part of the multiple-layered neural network. Further, a technique related to an autoencoder (self-encoding unit) or a vision transformer (ViT) may be applied to at least a part of the multiple-layered neural network.

In the present embodiment, an example will be described where a CNN is used as a machine learning model for noise reduction processing of a radiation image. FIG. 3B is a schematic diagram illustrating an example of the configuration 33 of the CNN constituting a neural network according to the present embodiment. In the example of a trained model according to the present embodiment, upon the input data 31, which is a radiation image, being input, the inference data 32 can be output as a radiation image with the noise reduced.

The CNN illustrated in FIG. 3B is composed of a plurality of groups of layers that perform processing to process input value groups to output the results. In addition, the types of the layers included in the configuration 33 of the CNN include the convolutional layer, the downsampling layer, the upsampling layer, and the merge layer. In the present embodiment, the configuration 33 of the CNN may further include an addition layer 34 to form a shortcut connection for adding input data before outputting. In this manner, the CNN can be configured to learn the difference between the input data and the output data, suitably handling the type of data group including noise.

The convolutional layer performs convolution processing on input value groups based on parameters of, for example, the kernel sizes of set filters, the number of filters, stride values, and dilation values. In addition, the number of dimensions of the kernel sizes of the filters may be changed depending on the number of dimensions of an input image.

The downsampling layer performs processing of decreasing the number of output value groups compared with the number of input value groups by thinning or merging the input value groups. Specifically, examples of such processing include max pooling.

The upsampling layer performs processing of increasing the number of output value groups compared with the number of the input value groups by duplicating an input value group or adding values interpolated from input value groups.

Specifically, examples of such processing include upsampling processing as transposed convolution.

The merge layer performs processing of inputting, from a plurality of sources, value groups, such as a pixel value group including an output value group and an image of a layer to merge the value groups by concatenating and adding the value groups.

In addition, the degree to which the tendencies trained using the training data can be reproduced during inference may vary with different settings for the parameters for the groups of layers and the groups of nodes constituting the neural network, to which attention should be paid. In other words, in many cases, since an appropriate parameter is different depending on the form when implemented, the parameter can be changed as appropriate.

In addition, other than the method of changing the parameters as described above, there is a case where the CNN can achieve a better characteristic by changing the configuration 33 of the CNN. The better characteristic means, for example, outputting a radiation image with the noise more accurately reduced, taking a shorter processing time, or taking a shorter time to train the machine learning model.

In addition, the configuration 33 of the CNN used in the present embodiment is a U-net machine learning model having a function of an encoder consisting of a plurality of hierarchical levels including a plurality of downsampling layers, and a function of a decoder consisting of a plurality of hierarchical levels including a plurality of upsampling layers. The U-net machine learning model can use a skip connection, for example. Specifically, positional information (spatial information) that has been made obscure in the plurality of hierarchical levels configured as the encoder can be used in the same dimensional hierarchical levels (hierarchical levels corresponding to the dimensions of the encoder) configured as the decoder.

While not illustrated in the drawings, as a modification example of the CNN configuration, for example, layers of an activation function (e.g., Rectifier Linear Unit (ReLu)) may be incorporated before and after the convolutional layer.

Features of noise can be extracted from an input radiation image through these steps of the CNN.

The training processing unit 261 includes the parameter update unit 265. As illustrated in FIG. 3C, the parameter update unit 265 calculates a loss function from the inference data 32 obtained by applying the neural network model of the inference processing unit 262 to the input data 31 of the training data, and ground truth data 35 included in the training data. Then, the parameter update unit 265 performs processing of updating the parameters of the neural network model based on the calculated loss function.

In this case, the loss function represents the error between the inference data 32 and the ground truth data 35.

The parameter update unit 265 can update filter coefficients of the convolutional layers and the like by using, for example, backpropagation so that the error between the inference data 32 and the ground truth data 35 expressed by the loss function becomes smaller. Backpropagation is a method for adjusting parameters between nodes of the neural network so that the error becomes smaller. In addition, for the training, a method (dropout) may be used of randomly inactivating each unit (each neuron or each node) included in the CNN.

Further, the trained model used by the inference processing unit 262 may be generated by using transfer learning. In this case, for example, the trained model used for noise reduction processing may be generated by performing transfer learning on the machine learning model trained by radiation images of the objects O of which, for example, the types are different. Performing such transfer learning makes it possible to efficiently generate a trained model even for an object O for which many pieces of the training data are difficult to acquire. Here, the objects O of which, for example, the types are different may be, for example, animals, plants, target objects for non-destructive inspection.

In this case, the GPU can perform efficient calculation by processing more pieces of data in parallel. For this reason, in a case where the training is performed a plurality of times using the machine learning model that employs the CNN as described above, it is effective for the GPU to perform the processing. Thus, the GPU is used in the training processing unit 261 according to the present embodiment in addition to the CPU. Specifically, in a case where a training program including the machine learning model is executed, the training is performed by the CPU and GPU performing the calculation in coordination. In addition, in the training processing, the calculation may be performed by the CPU or the GPU alone. Further, each process by the inference processing unit 262 may be implemented by using the GPU similarly to the training processing unit 261.

The configuration of the machine learning model has been described, but the machine learning model is not limited to the model using the CNN described above. The training of the machine learning model used in the present embodiment may be any type of machine learning using a model that can extract (represent) by the model itself features of the training data, such as images.

In this case, the training processing unit 261 according to the present embodiment can use any training data set for learning noise reduction processing. For example, the training processing unit 261 can use training data including an image with artificial noise added thereto as input data, and an image without the artificial noise as ground truth data. Other than these described above, for example, the training may be performed using training data including an image before addition averaging as input data, and an image after the addition averaging as ground truth data, or using training data including an image before statistical processing, such as maximum posteriori probability (MAP) estimation processing, as input data, and an image after the statistical processing as ground truth data. Further, the example of supervised learning has been described, but the training method is not limited thereto, and a method of any unsupervised learning or semi-supervised learning may be used.

### Operation of Noise Reduction Processing Unit

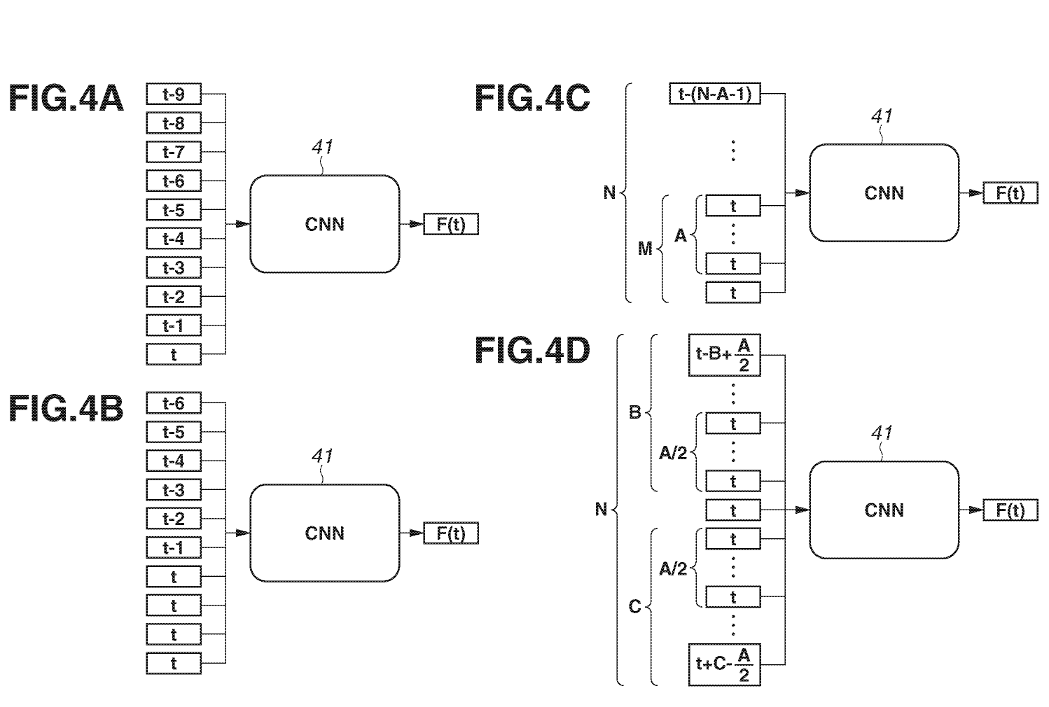

A detailed operation will be described of the noise reduction processing unit 26 during capturing a moving image with reference to FIGS. 4A to 4D. In moving image capturing, frames adjacent to a current frame often have similar structures to that of the current frame. For this reason, when noise reduction of a target pixel in the current frame is performed, temporal information as well as spatial information is used. In addition, spatial information represents similar structures around the target pixel in the current frame. Further, temporal information represents similar structures in the frames adjacent (previous or future frames) to the current frame.

The inference processing unit 262 can perform processing using more temporal information by inputting a plurality of frames to an input of a CNN 41. In this case, to perform real-time processing, the inference processing unit 262 is configured to input a current frame and a predetermined number of previous frames as input frames. Alternatively, the inference processing unit 262 is configured to input a current frame and a predetermined number of future frames. The number of frames input to the CNN 41 is N (N is an integer of two or more). The number of frames input to the CNN 41 varies depending on a frame rate during capturing images and required noise reduction performance. An example will now be described of N = 10 and a current frame and the previous frames being input.

FIG. 4A is a schematic diagram illustrating a configuration of a neural network in the case of N = 10. In the example illustrated in FIG. 4A, the current frame is described with the frame number denoted as t. In FIG. 4A, the current frame t and previous frames respectively having numbers t - 1 to t - 9 are sequentially input to the trained CNN 41. The CNN 41 is an example of a machine learning model held by the inference processing unit 262. Using the CNN 41 enables the inference processing unit 262 to acquire a noise reduced image F(t) subjected to noise reduction processing by using spatial information about the current frame t and temporal information about the nine previous frames.

FIG. 4B is a schematic diagram illustrating another configuration of a neural network in the case of N = 10. In the example in FIG. 4B, the current frames t, and the previous frames respectively having numbers t - 1 to t - 6 are input to the trained CNN 41. With N = 10, the number of the previous frames is reduced by three from that in the case of FIG. 4A, and three current frames t are added to the input. This configuration can reduce the number of previous frames used as compared with the case in FIG. 4A while the same CNN 41 as that illustrated in FIG. 4A is used. In addition, the current frame t is an example of a second frame image. The previous frames t - 1 to t - 6 are each an example of a third frame image.

Generalizing the frame configuration results in the form illustrated in FIG. 4C. In a case where the number of previous frames used is reduced by A from the configuration in which the current frame t and the previous frames t - 1 to t - (N - 1) are input, the current frames t × (A + 1) and the previous frames from t - 1 to t - (N - A - 1) can be used as the input. A denotes the number of frames, where 0 ≤ A < N. In addition, when the number of the current frames t is M, then M = A + 1, and the number of previous frames used is N - M.

In addition, FIG. 4A illustrates the case of N = 10, A = 0, and M = 1, and FIG. 4B illustrates the case of N = 10, A = 3, and M = 4.

This configuration allows the balance to be adjusted between the spatial information and the temporal information used in the noise reduction processing.

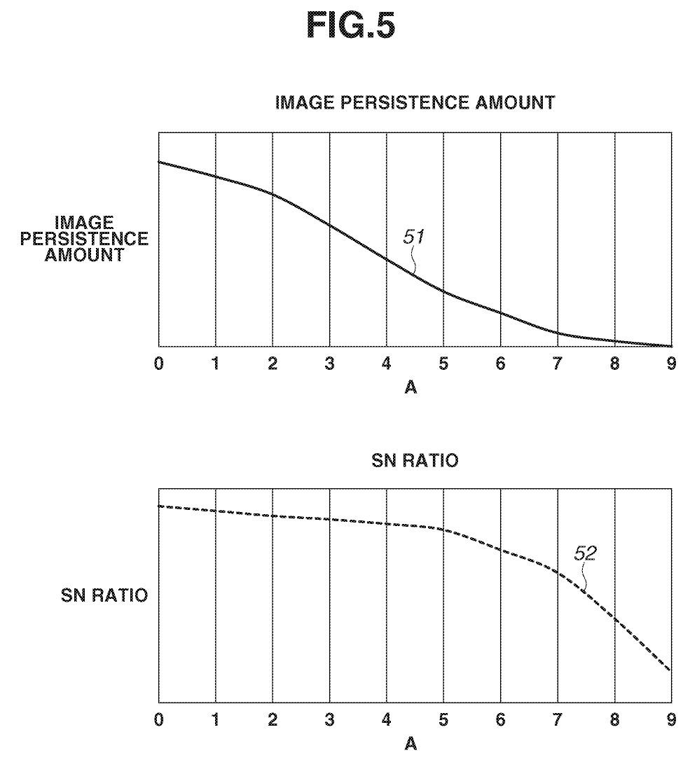

FIG. 5 is graphs illustrating changes in an amount of image persistence 51 and in a signal-to-noise (SN) ratio 52 when the number of frames A is changed (in the case of N = 10). As illustrated in FIG. 5, as the number of frames A is increased (temporal information is reduced), the amount of image persistence 51 is improved (decreased). On the other hand, FIG. 5 shows that as the number of frames A is increased (temporal information is reduced), the SN ratio 52 deteriorates (decreases). In the case of A = 0, since the temporal information can be used most, the amount of image persistence 51 is largest and the SN ratio 52 is highest. In the case of A = 9, since the temporal information is not used at all and only the spatial information is used, the amount of image persistence 51 is lowest, and the SN ratio 52 is lowest.

The amount of image persistence 51 decreases as the number of frames A increases. Further, the SN ratio 52 decreases as the number of frames A increases. The improvement of the amount of image persistence 51 and the improvement of the SN ratio 52 have a trade-off relationship. The operator can find the optimum number of frames A based on the motion of the object O by changing the number of frames A.

This configuration achieves both the effect of noise reduction and the effect of image persistence reduction by using a machine learning-based technique. Further, this enables the operator to intuitively adjust the trade-off between the effect of noise reduction (SN ratio improvement effect) and the effect of image persistence reduction.

### Another Configuration Example of Noise Reduction Processing Unit

The case has been described of N = 10 and only the current frame or frames, and the previous frames are input. However, the frames used for an input are not limited to the above-described examples. For example, as illustrated in FIG. 4D, in addition to current frames and previous frames, future frames can be used. In addition, the previous frames may be referred to as previous frame images. Similarly, the future frames may be referred to as future frame images.

FIG. 4D illustrates an example where one frame as the current frame t, B frames as the previous frames, and C frames as the future frames are used. The number of frames N input to the CNN 41 is N = B + C + 1. In this case, as illustrated in FIG. 4C, the number of the previous frames and the number of the future frames are reduced by A in total. For example, in a case where the same number of frames is each reduced from the number of the current frames and the number of the future frames (i.e., A/2 frames are reduced from the current frames, and A/2 frames are reduced from the future frames), the previous frames up to the t - B + (A/2) frame are input. Further, the future frames up to the t + C - A/2 frame are input. In addition, the current frame t is an example of a second frame image. Further, the previous frame expressed by t - B + (A/2) is an example of a third frame image. Further, the future frame expressed by t + C - A/2 is an example of a first frame image.

The number of previous frames B used and the number of future frames C used can be desirably changed.

Further, in a case where the number of the previous frames and the number of the future frames are reduced by A in total, a method other than that of reducing the same number of the frames from the number of the current frames and the number of the future frames (each reduced by 50%) can be employed. Specifically, the ratio can be desirably changed: for example, reducing the number of current frames by 40%, and reducing the number of future frames by 60%.

### Operation of Inference Processing Unit

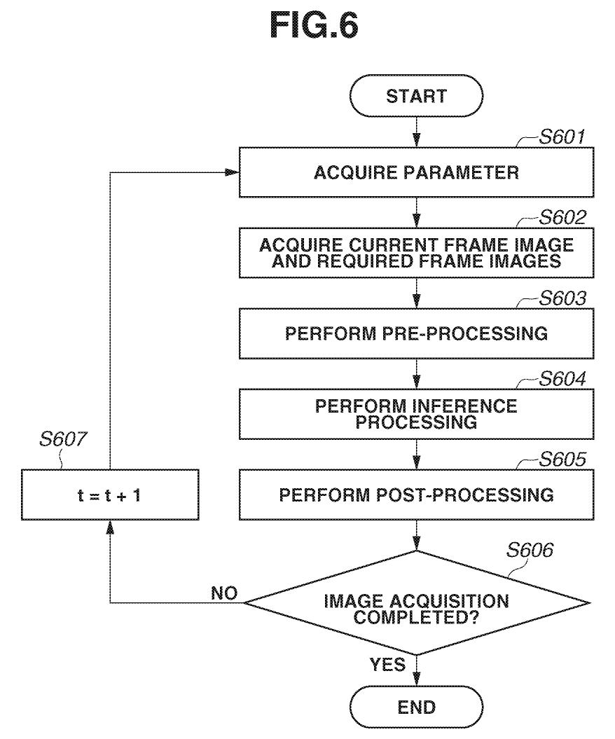

Detailed operations will be described of the noise reduction processing unit 26 and the inference processing unit 262 during moving image capturing with reference to FIG. 6. FIG. 6 is a flowchart illustrating an example of a processing procedure of the noise reduction processing unit 26 and the inference processing unit 262.

In step S601, the input adjustment unit 268 acquires a parameter that designates the trade-off between the amount of image persistence and the SN ratio. The parameter may be adjustable by a user from the display unit 50. Any form of the parameter is usable, and the parameter can be converted into the number of frames A as appropriate.

In step S602, the input adjustment unit 268 acquires a current frame image and images of previous or future frames before or after the current frame designated by A via the acquisition unit 21, and arranges the acquired frame images in appropriate order. For example, the frames can be sequentially arranged from the past to the future as illustrated in FIG. 4D.

In step S603, the pre-processing unit 266 performs pre-processing for performing appropriate inference processing on the images acquired in step S602 to provide pre-processed images. The pre-processing method is not particularly limited. For example, the noise reduction processing includes square-root transformation, logarithmic transformation, and Anscombe transformation. These transformations allow the quantum noise following a Poisson distribution to be made approximately constant regardless of the intensity of the radiation emitted, allowing the noise included in the input image to be treated as additive noise. Further, as the pre-processing, centering can be performed to set the mean value of the data to zero in order to stabilize processing by the neural network. Alternatively, standardization can be performed to set the standard deviation of the data to one. Alternatively, normalization can be performed to normalize data to the range of zero to one. Alternatively, both the centering to set the mean value of the data to zero and the standardization to set the standard deviation of the data to one can be performed. With a large size of the image to be handled that makes batch processing by the neural network difficult, the image may be divided into a plurality of ROIs each having an arbitrary size. In order to increase quality of the calculation result at an image boundary, padding processing for an appropriate size can be performed.

A result of the above-described pre-processing can be temporarily stored in a memory as necessary so that the result can be used in the inference processing for subsequent frames. In addition, it is desirable for the pre-processing performed by the pre-processing unit 266 to be the same processing at the time of inference and the time of training.

In step S604, the inference processing unit 262 performs inference processing on the pre-processed image acquired in step S603, using the trained model. In this way, an image with the noise reduction processing applied thereto can be obtained.

In step S605, the post-processing unit 267 performs post-processing on the result of the inference processing obtained in step S603. The post-processing reverses the pre-processing performed in step S603, such as an inverse transformation to the normalization and the leveling, removal processing of the padded portion, and connection of the plurality of ROIs obtained through the division of the ROIs.

In step S606, the noise reduction processing unit 26 determines whether to end the image acquisition. In addition, the noise reduction processing unit 26 may determine whether to end the image acquisition based on, for example, the set image capturing conditions or an instruction from the operator. If the image acquisition is continued (NO in step S606), the processing proceeds to step S607. In step S607, the noise reduction processing unit 26 adds one to the frame number t, and the processing proceeds to step S601. The noise reduction processing unit 26 then repeats the processing in steps S601 to S606. If the image acquisition is not continued (YES in step S606), the processing ends.

### Operation of Training Processing Unit

In addition, as the training data used in training by the training processing unit 261, N frames are configured to be input in the CNN 41 as the input data in the same manner as the time of inference. Further, the CNN 41 is configured to learn patterns including a pattern with the number of frames A changed at random as a pattern of the input data. By training as described above, the characteristics (i.e., the amount of image persistence 51 decreases as the A increases, and the SN ratio 52 decreases as the A increases) illustrated in FIG. 5 can be achieved.

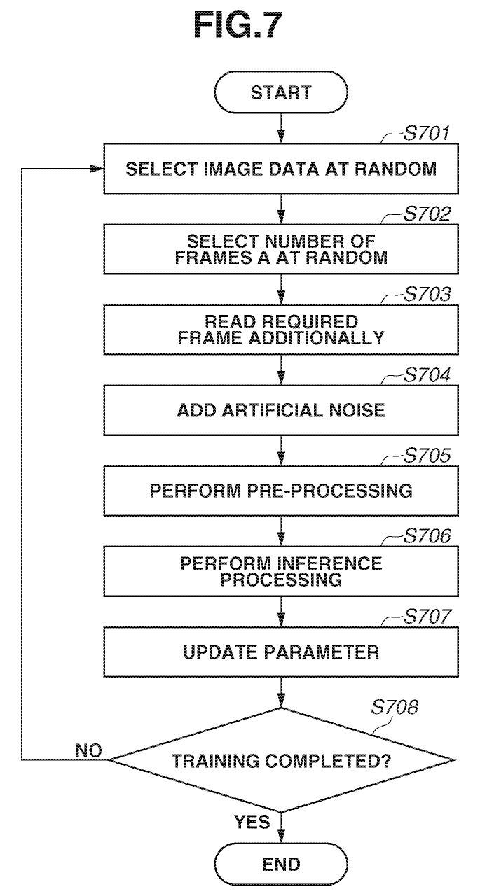

Detailed operations of the noise reduction processing unit 26 and the training processing unit 261 in the moving image capturing will be described with reference to FIG. 7. FIG. 7 is a flowchart illustrating an example of a processing procedure of the noise reduction processing unit 26 and the training processing unit 261. An example will now be described where the training processing unit 261 performs supervised learning, and as a training data set for learning the noise reduction processing, an image with artificial noise added thereto is input data, and an image without the artificial noise is ground truth data. Further, in the present embodiment, the CNN 41 to be a training target is assumed to be a system in which frames consisting of a total of N frames including current frames and previous frames are input, and a current frame with the noise reduced therein is output.

In step S701, the training data generation unit 264 randomly selects image data from the storage unit 25 that stores a plurality of pieces of image data. As the data for learning the noise reduction processing on the moving image, for example, a plurality of moving images including a plurality of frames can be suitably used. Further, it is desirable for the moving image to have a good SN ratio. The moving image may be, for example, a moving image with the SN ratio improved by performing other noise reduction processing on the moving image in advance. The training data generation unit 264 randomly selects a moving image, and acquires an image with a random frame number = Tr from the selected moving image. In addition, the image with the frame number = Tr is an example of a fourth frame image.

In step S702, the input adjustment unit 268 selects the number of frames A at random (0 ≤ A < N). By learning patterns including the patterns with the number of frames A changed at random, the trade-off relationship between the SN ratio improvement effect and the image persistence at the time of inference processing can be adjusted by changing the number of frames A.

In step S703, the input adjustment unit 268 reads the previous frames up to the frame number (Tr - (N - A - 1)) based on the number of frames A selected in step S702, the number of input frames N of the CNN 41, and the random frame number Tr selected in step S701. The read previous frames are arranged in the order as illustrated in FIG. 4C.

In step S704, the training data generation unit 264 adds artificial noise generated by simulating the characteristic of the radiation image corresponding to each of the images with the frame numbers Tr - (N - A - 1) to Tr. It is desirable for artificial noise to be generated by simulating an actual radiation image in consideration of the sensitivity of the radiation detector 10, noise characteristics of a read-out circuit, and a modulation transfer function (MTF) of the scintillator 11. Through the above-described steps, the training data can be configured to include the images having the frame numbers Tr - (N - A - 1) to Tr with the artificial noise added thereto as the input data and the image of the frame number Tr without the artificial noise as the ground truth data. In addition, the image of the frame number Tr with the artificial noise added thereto is an example of a fifth frame image.

In step S705, the pre-processing unit 266 performs pre-processing for appropriate inference processing on the training data acquired in step S702 to provide the pre-processed training data. The details of the pre-processing are as described above.

In step S706, the inference processing unit 262 inputs the pre-processed input data to the CNN 41 to output an inference result by applying parameters of the CNN 41 in the learning process.

In step S707, the parameter update unit 265 performs processing of updating the parameters of the CNN 41 so as to minimize the loss function as appropriate based on the inference result provided in step S706 and the ground truth data.

In step S708, the training processing unit 261 determines whether to end the training. Ending the training may be determined based on any criterion, such as the number of times the processing is repeated (the number of iterations), the value of the loss function, or whether overfitting occurs. If the training is completed (YES in step S708), the processing of this flowchart ends, and the update of the parameters of the CNN 41 is stopped. The CNN 41 can be used for the above-described various types of inference processing as the trained CNN. If the training is continued (NO in step S708), the processing returns to step S701. The training processing unit 261 then repeats the processing in steps S701 to S708.

In addition, the number of frames A may be limited to any number (zero or more) based on the trade-off relationship between the SN ratio improvement effect and the amount of image persistence as illustrated in FIG. 5. The smaller the number of frames A is, the smaller the number of training patterns can be, increasing the efficiency of training the CNN 41.

The configuration described above achieves both the effect of noise reduction and the effect of image persistence reduction by using the machine learning-based technique. Further, the operator can intuitively adjust the trade-off between the effect of noise reduction (the SN ratio improvement effect) and the effect of image persistence reduction.

### Modification Example 1

The machine learning model used by the inference processing unit 262 has a configuration of a combination of arbitrary layer structures, such as variational auto-encoder (VAE), Fully Convolutional Network (FCN), SegNet, and DenseNet, as a configuration of the CNN. Further, the machine learning model may have a configuration, for example, using Vision Transformer (ViT).

### Modification Example 2

Further, the training data about the various types of trained models is not limited to the data obtained by using the radiation detector itself actually used to perform image capturing, and the training data may be obtained by using the same model radiation detector, or by using the same type of radiation detector depending on a desired configuration. In addition, it is conceivable that the trained model according to the above-described embodiment and the modification example, for example, extracts the magnitude or the like of a brightness value of a radiation image as a part of features to use the extracted information in the inference processing related to generation of an radiation image subjected to various types of image processing. In addition, other than that, examples of the features include the order and the gradient of light and dark areas, the positions, the distribution, and the continuity.

In addition, the trained model according to the above-described embodiment and the modification example can be provided in the control unit 20. For example, the trained model may be configured with software modules, or the like executed by a processor, such as a CPU, an MPU, a GPU, and an FPGA, and may be configured with a circuit or the like, such as an ASIC that carries out a specific function. Further, these trained models may be provided in a different server device or the like connected to the control unit 20. In this case, the control unit 20 can use the trained model with the control unit 20 connected to the server or the like provided with the trained model via an arbitrary network, such as the Internet. The server including the trained model may be, for example, a cloud server, a fog server, or an edge server.

### Modification Example 3

Further, in the above-described embodiment and the modification examples, the radiation detector 10 is an indirect conversion type detector that converts radiation into visible light using the scintillator 11, and then converts the visible light into an electrical signal using a photoelectric conversion device. However, the radiation detector 10 may be a direct conversion type detector that directly converts incident radiation into an electrical signal.

According to the present disclosure, an image processing apparatus can be provided that is capable of performing noise reduction processing using a trained model to change the amount of image persistence reduction.

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-005362, which was filed on January 15, 2025 and which is hereby incorporated by reference herein in its entirety.

What is claimed is:

1. An image processing apparatus comprising:
at least one processor; and
at least one memory that is in communication with the at least one processor, wherein the at least one memory stores instructions for causing the at least one processor and the at least one memory to:
acquire a frame image including noise less than noise of a plurality of second frame images using the plurality of second frame images and using at least one of a first frame image and a third frame image,
wherein a moving image includes the first frame image, the plurality of second frame images, and the third frame image,
wherein the plurality of second frame images was captured before the first frame image was captured, and
wherein the third frame image was captured before the plurality of second frame images was captured.

2. The image processing apparatus according to claim 1,
wherein the moving image includes a plurality of previous frame images acquired before the plurality of second frame images, the plurality of previous frame images including the third frame image, and a plurality of future frame images acquired after the plurality of second frame images, the plurality of future frame images including the first frame image, and
wherein the at least one memory further stores instructions for causing the at least one processor and the at least one memory to acquire the frame image including noise less than the noise of the plurality of second frame images using the plurality of second frame images, and at least one of the plurality of previous frame images and the plurality of future frame images.

3. The image processing apparatus according to claim 2,
wherein the at least one memory further stores instructions for causing the at least one processor and the at least one memory to use a trained model configured to acquire a frame image with the noise reduced by N (N ≥ 2) frames being input, and
wherein a sum of the number of the previous frame images and the number of the future frame images is N − M in a case where the number of the plurality of second frame images input in the trained model is M (1 ≤ M ≤ N).

4. The image processing apparatus according to claim 3, wherein the trained model is trained using a fourth frame image serving as ground truth data, and a plurality of frame images serving as input data obtained by adding artificial noise to each frame of the moving image including the fourth frame image.

5. The image processing apparatus according to claim 4,
wherein the trained model is trained by using a plurality of fifth frame images obtained by adding artificial noise to the fourth frame image included in the input image data, and
wherein the number of the fifth frame images used in the training is changed at random each time training is performed.

6. The image processing apparatus according to claim 1, wherein the number of the plurality of second frame images is changeable by an operation performed by an operator.

7. The image processing apparatus according to claim 6, wherein the at least one memory further stores instructions for causing the at least one processor and the at least one memory to, in a case where the operator performs the operation so as to increase the number of the plurality of second frame images, acquire a frame image including image persistence reduced compared with image persistence in the frame image before the number of the plurality of second frame images is increased.

8. The image processing apparatus according to claim 6, wherein the at least one memory further stores instructions for causing the at least one processor and the at least one memory to, in a case where the operator performs the operation so as to reduce the number of the plurality of second frame images, acquire the frame image including noise less than the noise of the frame image before the number of the plurality of second frame images is reduced.

9. A radiographic imaging system comprising:
a radiation detector configured to detect radiation, and
the image processing apparatus according to claim 1 communicably connected to the radiation detector.

10. An image processing method of an image processing apparatus configured to perform image processing on a moving image including a first frame image, a plurality of second frame images captured before the first frame image, and a third frame image captured before the plurality of second frame images, the method comprising:
acquiring a frame image including noise less than noise of the plurality of second frame images using the plurality of the second frame images and using at least one of the first frame image and the third frame image.

11. A non-transitory computer-readable storage medium storing computer-executable instructions for causing a computer to execute an image processing method of an image processing apparatus configured to perform image processing on a moving image including a first frame image, a plurality of second frame images captured before the first frame image, and a third frame image captured before the plurality of second frame images, the method comprising:
acquiring a frame image including noise less than noise of the plurality of second frame images using the plurality of the second frame images and using at least one of the first frame image and the third frame image.
